(19) United States
(12) Patent Application Publication
(10) Pub. No.: US 2004/0151473 A1
(43) Pub. Date: Aug. 5, 2004

(54) Audio/video data recording/reproduction apparatus, system, and method, recording medium recorded by them, audio/video data reproduction apparatus, and data structure

(76) Inventor: Masanori Itoh, Osaka (JP)

Correspondence Address: Merchant & Gould, PO Box 2903, Minneapolis, MN, 55402-0903, US

(21) Appl. No.: 10/479,692

(22) PCT Filed: Jan. 27, 2003
(86) PCT No.: PCT/JP03/00706

(30) Foreign Application Priority Data
Jan. 29, 2002 (JP) 2002-20406

(51) Int. Cl. H04N 5/76

(52) U.S. Cl. 386/83; 386/111

(57) ABSTRACT

An audio/video data recording apparatus capable of describing a recording start time directly in a play list when reproducing a moving picture by specifying a time interval. When recording a moving picture, a recording start time is recorded as a time code in a GOP header which is management data for each of the contiguous portions (#0, #1) in each moving picture file. When reproducing the moving picture, a moving picture reproduction interval is specified by using the recording start time held in the time code field in the GOP header.

### TECHNICAL FIELD

The present invention relates to techniques for specifying a reproduction start time and a reproduction end time with a play list in, for example, a video camera that records moving pictures on a recording medium such as an optical disk, and reproducing the moving pictures in that time period.

### BACKGROUND ART

As methods for compressing audio and video constituting moving pictures at a low bit rate, the following three types are defined by the MPEG2 standard (ISO/IEC 13818-1): program stream, transport stream and PES stream.

On the other hand, optical disks such as DVD-RAMs and MOs (magneto-optical disks) have garnered attention as video recording media replacing magnetic tapes. FIG. 11 is a functional block diagram showing an example of the configuration of a conventional audio/video data recording/reproducing apparatus 200 using a DVD-RAM disk. In FIG. 11, signals input from a video signal input section 100 and an audio signal input section 102 are compressed in a video compressing portion 101 and an audio compressing section 103, respectively, and transport streams are produced in a system encoding section 104 and are written on a DVD-RAM disk 131 via a recording section 120 and a pick-up 130.

When reproducing moving pictures, the transport streams taken out via the pick-up 130 and a reproducing section 121 are separated into video signals and audio signals in a system decoding section 114 and are output to a video display section 110 and an audio output section 112 via a video decoding section 111 and an audio decoding section 113, respectively.

When recording moving pictures, a recording control section 161 controls the recording section 120. A contiguous data area detecting section 160 checks the use status of the sectors managed by a logical block management section 163 in response to an instruction from the recording control section 161 and detects physically contiguous free spaces.

A play list for the recorded moving picture files is input via a reproducing control information input section 150 and recorded via the recording section 120 and the pick-up 130. At this time, the play list is produced with the reproducing control information input section 150 by, for example, a user performing the operation for producing the play list while watching the video display section 110 of the recording/reproducing apparatus. The play list is described in SMIL language (The Synchronized Multimedia Integration Language) Version 2.0 of W3C (The World Wide Web Consortium). FIG. 12 shows an example of the produced play list. FIG. 12 shows the contents of the play list that reproduces the data in a time period from the start of the moving picture file having the file name “MOVE0001.MPG” to 10 minutes thereafter. Here, as the method for specifying the time period, a reproduction start point is specified by “clipBegin”, and a reproduction end point is specified by “clipEnd”.

The “clipBegin” or “clipEnd” specifies the reproduction start time or the reproduction end time by an offset value of a time measured with the first image of the file as the starting point. As the specifying format, a time code format in compliance with SMPTE (Society of Motion Picture Television Engineers) specifications (“Time and Control Codes for 24, 25 or 30 Frame-Per-Second Motion-Picture Systems—RP136-1995”) is used. In the example shown in FIG. 12, the start of the file is specified by “0:0:0:0”, and the time ten minutes thereafter is specified by “0:10:0:0”. In addition, “1 hour, 2 minutes, 3 seconds, 4th frame”, for example, would be specified by “1:2:3:4”.

On the other hand, according to the MPEG2-Video standard, a GOP header always contains a time code field, and a given time code value can be set in the form “hours:minutes:seconds:number of pictures”. However, the value itself may be counted from a given value. In the case of a broadcast wave, for example, when moving pictures are stored in a cassette tape deck (e.g., D5 deck) before they are broadcast, a time code serving as a tape counter indicating a position in the cassette tape is inserted in a moving picture file.

The reproducing control information input section 150 may be a digital interface such as a USB. By connecting a personal computer (PC) to the recording/reproducing apparatus with a digital interface, a play list file produced on the PC may be taken into the recording/reproducing apparatus via the digital interface. If the recording/reproducing apparatus can be connected to the Internet, a play list exclusive for a broadcast program may be taken in from a Web server of a broadcasting station of a broadcast wave that is connected to the Internet.

However, the above-described conventional recording/reproducing apparatus had the following problems.

First, in the case of capturing moving pictures with a video camera, it was impossible to describe the capturing time directly in a play list by using the SMIL language, in order to specify a period to be reproduced.

In the case of recording a broadcast wave, the recording start time may differ from one user to another. This happens, for example, when the clock used for the programmed recording differs from one user to another. When recording is started by manual operations, the recording start time may be, for example, 10 minutes after the start of a broadcast program. Thus, when the recording start time differs from one user to another, it becomes impossible to use the same play list for the same broadcast program.

In addition, when necessary scenes are selected and a play list is produced for them, followed by deleting unnecessary scenes, the times described in the play list had to be changed.

### DISCLOSURE OF INVENTION

The present invention was achieved in view of the above-described problems and it is an object of the present invention to make it possible to describe a capturing time directly in a play list, thereby specifying a period to be reproduced.

It is another object of the present invention to make it possible to control, with a single play list, reproduction of a moving picture file in which a broadcast program is recorded, even when the recording start time differs from one user to another.

It is yet another object of the present invention to eliminate the need to change the contents of a play list even if unnecessary scenes are deleted from a moving picture file recorded after producing the play list.

In order to achieve the above-described objects, a first audio/video data recording/reproducing apparatus of the present invention includes: audio/video data generating means that generate audio/video data from an audio signal and/or video signal; audio/video data recording means that record, as a file, audio/video data generated by the audio/video data generating means; and reproducing means that reproduce a specified time period of audio and/or video data recorded by the audio/video data recording means. The audio/video data recording means further record identification information for identifying a time-wise contiguous recording period and further record a recording start time (capturing start time) in a unit of the identification information. The reproducing means identify the specified time period based on a name of the file, the identification information and position information taking the recording start time as a starting point.

In the first audio/video data recording/reproducing apparatus, it is preferable that when it is determined, by referring to the recording start time, that the audio and/or video data corresponding to the specified time period contain an unrecorded portion, the reproducing means immediately reproduce only a recorded portion.

In order to achieve the above-described objects, a second audio/video data recording/reproducing apparatus of the present invention includes: audio/video data recording means that record, as a file, audio/video data in which time information (time code) is inserted for every predetermined signal unit; and reproducing means that reproduce a specified time period of audio and/or video data recorded by the audio/video data recording means. The audio/video data recording means further record identification information for identifying a time-wise contiguous recording period and further record the time information of a start in a single contiguous recording period in a unit of the identification information. The reproducing means identify the specified time period based on a name of the file, the identification information and position information taking the time information as a starting point.

In the second audio/video data recording/reproducing apparatus, the time information is information including a time at which an audio signal and/or video signal is generated before being converted into the audio and/or video data.

In the second audio/video data recording/reproducing apparatus, it is preferable that the audio/video data are MPEG data, and the audio/video data recording means record the time information in a time code field in a GOP header.

In the second audio/video data recording/reproducing apparatus, it is preferable that when it is determined, by referring to the time information, that the audio and/or video data corresponding to the specified time period contain an unrecorded portion, the reproducing means immediately reproduce only a recorded portion.

In order to achieve the above-described objects, a first audio/video data recording/reproducing method of the present invention includes the steps of: generating audio/video data from an audio signal and/or video signal; recording the generated audio/video data as a file; and reproducing a specified time period of the recorded audio and/or video data. The recording step includes a step of further recording identification information for identifying a time-wise contiguous recording period and further recording a recording start time (capturing start time) in a unit of the identification information. The reproducing step includes a step of identifying the specified time period based on a name of the file, the identification information and position information taking the recording start time as a starting point.

In the first audio/video data recording/reproducing method, it is preferable that when it is determined, by referring to the recording start time, that the audio and/or video data corresponding to the specified time period contain an unrecorded portion, the reproducing step includes a step of immediately reproducing only a recorded portion.

In order to achieve the above-described objects, a second audio/video data recording/reproducing method of the present invention includes the steps of: recording, as a file, audio/video data in which time information is inserted for every predetermined signal unit; and reproducing a specified time period of the recorded audio and/or video data. The recording step includes a step of further recording identification information for identifying a time-wise contiguous recording period and further recording the time information of a start in a single contiguous recording period in a unit of the identification information. The reproducing step includes a step of identifying the specified time period based on a name of the file, the identification information and position information taking the time information as a starting point.

In the second audio/video data recording/reproducing method, the time information is information including a time at which an audio signal and/or video signal is generated before being converted into the audio and/or video data.

In the second audio/video data recording/reproducing method, it is preferable that the audio/video data are MPEG data, and the time information is recorded in a time code field in a GOP header.

In the second audio/video data recording/reproducing method, it is preferable that when it is determined, by referring to the time information, that the audio and/or video data corresponding to the specified time period contain an unrecorded portion, the reproducing step includes a step of immediately reproducing only a recorded portion.

In order to achieve the above-described objects, a first audio/video data reproducing apparatus of the present invention includes reproducing means that reproduce a specified time period of audio and/or video data recorded as a file. The reproducing means identify the specified time period based on a name of the file, identification information recorded for identifying a time-wise contiguous recording period and position information taking, as a starting point, a recording start time (capturing start time) recorded in a unit of the identification information.

In the first audio/video data reproducing apparatus, it is preferable that when it is determined, by referring to the recording start time, that the audio and/or video data corresponding to the specified time period contain an unrecorded portion, the reproducing means immediately reproduce only a recorded portion.

In order to achieve the above-described objects, a second audio/video data reproducing apparatus of the present invention includes reproducing means that reproduce a specified time period of audio and/or video data recorded as a file in which time information is inserted for every predetermined signal unit. The reproducing means identify the specified time period based on a name of the file, identification information recorded for identifying a time-wise contiguous recording period and position information taking, as a starting point, the time information of a start in a single contiguous recording period recorded in a unit of the identification information.

In the second audio/video data reproducing apparatus, the time information is information including a time at which an audio signal and/or video signal is generated before being converted into the audio and/or video data.

In the second audio/video data reproducing apparatus, it is preferable that the audio/video data are MPEG data, and the reproducing means reproduce the time information recorded in a time code field in a GOP header.

In the second audio/video data reproducing apparatus, it is preferable that when it is determined, by referring to the time information, that the audio and/or video data corresponding to the specified time period contain an unrecorded portion, the reproducing means immediately reproduce only a recorded portion.

In order to achieve the above-described objects, a first audio/video data recording/reproducing system of the present invention includes: audio/video data generating means (broadcasting station) that convert an audio signal and/or video signal into audio/video data and insert time information (time code) in the audio/video data for every predetermined signal unit; transmission means (broadcast wave, the Internet) that transmit audio/video data generated by the audio/video data generating means; audio/video data recording means that record, as a file, audio/video data transmitted by the transmission means; and reproducing means that reproduce a specified time period of audio and/or video data recorded by the audio/video data recording means. The audio/video data recording means further record identification information for identifying a time-wise contiguous recording period and further record the time information of a start in a single contiguous recording period in a unit of the identification information. The reproducing means identify the specified time period based on a name of the file, the identification information and position information taking the time information as a starting point.

In the first audio/video data recording/reproducing system, the time information is information including a time at which an audio signal and/or video signal is generated before being converted into the audio/video data.

In the first audio/video data recording/reproducing system, it is preferable that the audio/video data generating means generate MPEG data, and the audio/video data recording means record the time information in a time code field in a GOP header.

In the first audio/video data recording/reproducing system, it is preferable that when it is determined, by referring to the time information, that the audio and/or video data corresponding to the specified time period contain an unrecorded portion, the reproducing means immediately reproduce only a recorded portion.

In order to achieve the above-described objects, a second audio/video data recording/reproducing system of the present invention includes: audio/video data sending means (broadcasting station) that send audio and/or video data in which time information is inserted at a predetermined interval; first transmission means (broadcast wave, cable) that transmit the audio/video data; reproducing control information sending means (Web server) that send reproducing control information (play list) regarding the audio and/or video data; second transmission means (the Internet) that transmit the reproducing control information; recording means that record the audio data and/or video data transmitted by the first transmission means and the reproducing control information transmitted by the second transmission means; and reproducing means that reproduce the audio and/or video data for a selected reproduction period in accordance with the reproducing control information.

In the second audio/video data recording/reproducing system, it is preferable that when it is determined, by referring to the time information, that the audio and/or video data corresponding to a reproduction period specified in the reproducing control information contain an unrecorded portion, the reproducing means immediately reproduce only a recorded portion.

In order to achieve the above-described objects, a third audio/video data recording/reproducing method of the present invention includes the steps of: converting an audio signal and/or video signal into audio/video data and inserting time information in the audio/video data for every predetermined signal unit; transmitting the audio/video data; recording transmitted audio/video data as a file; and reproducing a specified time period of recorded audio and/or video data. The recording step includes a step of further recording identification information for identifying a time-wise contiguous recording period and further recording the time information of a start in a single contiguous recording period in a unit of the identification information. The reproducing step includes a step of identifying the specified time period based on a name of the file, the identification information and position information taking the time information as a starting point.

In the third audio/video data recording/reproducing method, the time information is information including a time at which an audio signal and/or video signal is generated before being converted into the audio/video data.

In the third audio/video data recording/reproducing method, it is preferable that the audio/video data are MPEG data, and the time information is recorded in a time code field in a GOP header.

In the third audio/video data recording/reproducing method, it is preferable that when it is determined, by referring to the time information, that the audio and/or video data corresponding to the specified time period contain an unrecorded portion, the reproducing step includes a step of immediately reproducing only a recorded portion.

In order to achieve the above-described objects, a fourth audio/video data recording/reproducing method of the present invention includes: a step of sending audio and/or video data in which time information is inserted at a predetermined interval; a first transmission step of transmitting the audio/video data; a step of sending reproducing control information regarding the audio data and/or video data; a second transmission step of transmitting the reproducing control information; a step of recording the audio data and/or video data transmitted in the first transmission step and the reproducing control information transmitted in the second transmission step; and a step of reproducing the audio data and/or video data for a selected reproduction period in accordance with the reproducing control information.

In the fourth audio/video data recording/reproducing method, it is preferable that when it is determined, by referring to the time information, that the audio and/or video data corresponding to a reproduction period specified in the reproducing control information contain an unrecorded portion, the reproducing step includes a step of immediately reproducing only a recorded portion.

In order to achieve the above-described objects, a first recording medium of the present invention is recorded by the first or second audio/video data recording/reproducing apparatus.

In order to achieve the above-described objects, a second recording medium of the present invention is recorded by any of the first to fourth audio/video data recording/reproducing methods.

In order to achieve the above-described objects, a third recording medium of the present invention is recorded by the first or second audio/video data recording/reproducing system.

In order to achieve the above-described objects, a data structure of the present invention specifies a time period for reproducing audio and/or video data recorded as a file, and the data structure has a format including at least a name of the file, information (rec, GOP) relating to a generation of an audio signal and/or video signal before being converted into the audio data and/or video data, identification information (#0, #1, . . . ) for identifying a time-wise contiguous recording period, a reproduction start time and a reproduction end time.

### BRIEF DESCRIPTION OF DRAWINGS

FIG. 1 is a schematic configuration diagram of an audio/video data recording/reproducing system according to a first embodiment of the present invention.

FIG. 2 is a functional block diagram showing an example of the configuration of an audio/video data recording/reproducing apparatus 2 in the first embodiment.

FIG. 3 is a diagram showing the data structure of a moving picture file recorded by one user in the first embodiment.

FIG. 4 is a diagram showing the data structure of a moving picture file recorded by an another user in the first embodiment.

FIG. 5 is a diagram showing an example of the play list file in the first embodiment.

FIG. 6A is a diagram showing the contents of the management data of each contiguous data portion that is held in the footer of each moving picture file in the first embodiment.

FIG. 6B is a diagram showing the contents of the management data of each MOBU.

FIG. 7 is a diagram showing another example of the play list file in the first embodiment.

FIG. 8 is a diagram showing yet another example of the play list file in the first embodiment.

FIG. 9 is a diagram showing an example of the play list file in a second embodiment of the present invention.

FIG. 10A is a diagram showing the contents of the management data of each contiguous data portion that are held in the footer of each moving picture file in the second embodiment.

FIG. 10B is a diagram showing the contents of the management data of each MOBU.

FIG. 11 is a functional block diagram showing an example of the configuration of a conventional audio/video data recording/reproducing apparatus 200.

FIG. 12 is a diagram showing an example of the conventional play list file.

FIG. 13 is a functional block diagram showing an example of the configuration of an audio/video data recording/reproducing apparatus 20 according to a third embodiment of the present invention.

FIG. 14 is a diagram showing the data structure of a moving picture file recorded by a user in the third embodiment.

FIG. 15 is a diagram showing an example of the identification information of the frames in the embodiments of the present invention that are displayed on a display.

### BEST MODE FOR CARRYING OUT THE INVENTION

Preferred embodiments of the present invention will be described with reference to the drawings.

### First Embodiment

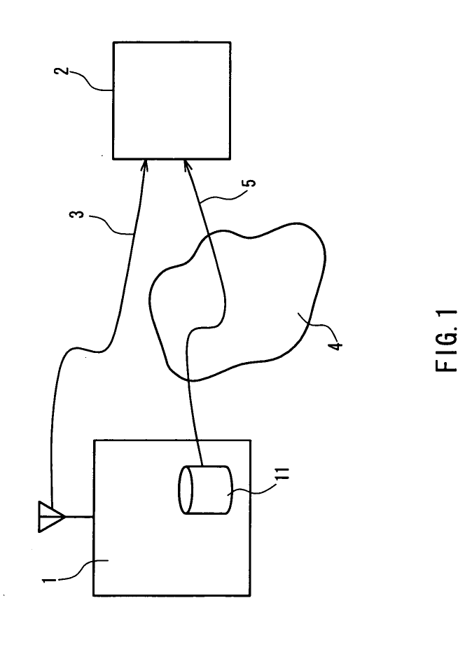

FIG. 1 is a schematic configuration diagram of an audio/video data recording/reproducing system according to a first embodiment of the present invention. In FIG. 1, numeral 1 denotes a broadcasting station (audio/video data generating means, audio/video data sending means), numeral 2 denotes an audio/video data recording/reproducing apparatus of the present invention, numeral 3 denotes moving picture streams of a broadcast program transmitted from the broadcasting station 1 to the audio/video data recording/reproducing apparatus 2 by a broadcast wave (transmission means, first transmission means), numeral 4 denotes the Internet (transmission means, second transmission means), and numeral 5 denotes a play list (data structure) downloaded to the audio/video data recording/reproducing apparatus 2 from a Web server 11 (reproducing control information sending means) of the broadcasting station 1 via the Internet 4.

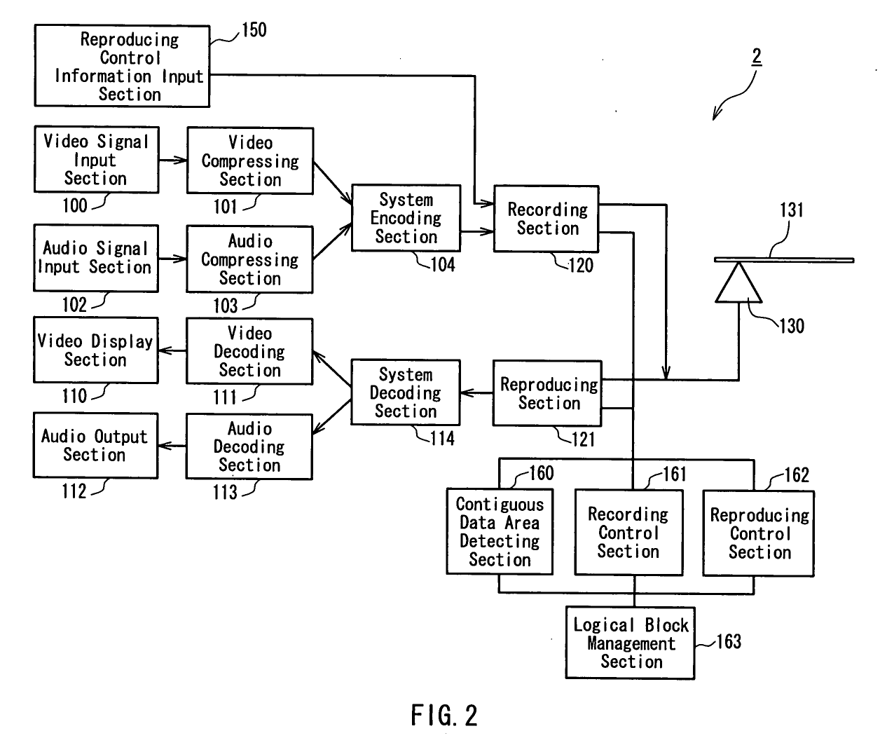

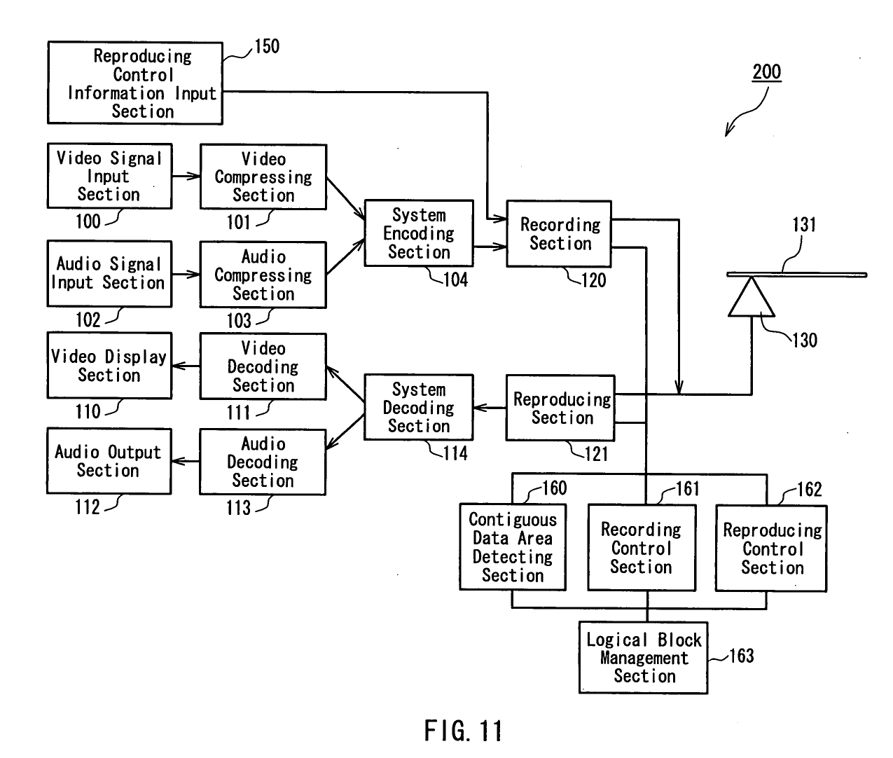

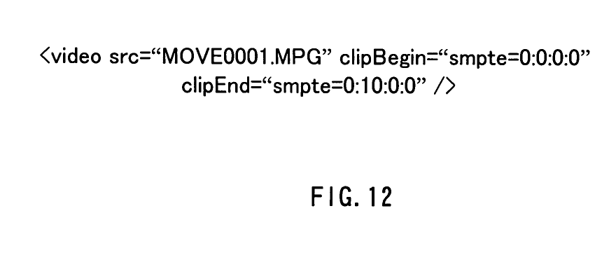

FIG. 2 is a functional block diagram showing an example of the configuration of the audio/video data recording/reproducing apparatus 2 shown in FIG. 1. In FIG. 2, although the configuration of this embodiment and that of the conventional example shown in FIG. 11 are the same, the data generated by the video compressing section 101 and the system encoding section 104 are different.

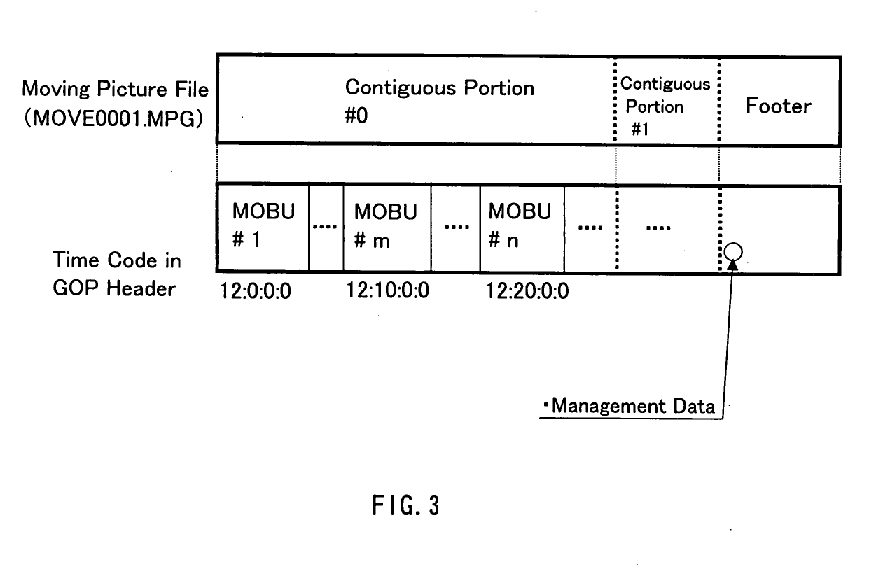

FIG. 3 is a schematic diagram showing the configuration of a moving picture file produced by one user by recording the moving picture streams of two broadcast programs and then combining them into a single moving picture file. In FIG. 3, the moving picture file is constituted by a contiguous portion #0, a contiguous portion #1 and a footer. A single contiguous portion is assumed to be a part of a single broadcast program in which video and audio are time-wise contiguous. A single contiguous portion is constituted by a plurality of MOBUs (Movie Object Units). Each MOBU includes a sequence header, 0.4 second to 1 second of video and audio corresponding to the video. The video in each MOBU is constituted by at least one GOP (Group of Picture). In a time code field in the GOP header in each GOP, a time code corresponding to the time at which the video was generated is set. In FIG. 3, as the time code, “12:0:0:0” is set in MOBU #1, “12:10:0:0” is set in MOBU #m and “12:20:0:0” is set in MOBU #n. The time code fields in the GOP header are discontinuous at a boundary between the contiguous portion #0 and the contiguous portion #1. Additionally, the contents of the broadcast program change across the boundary.

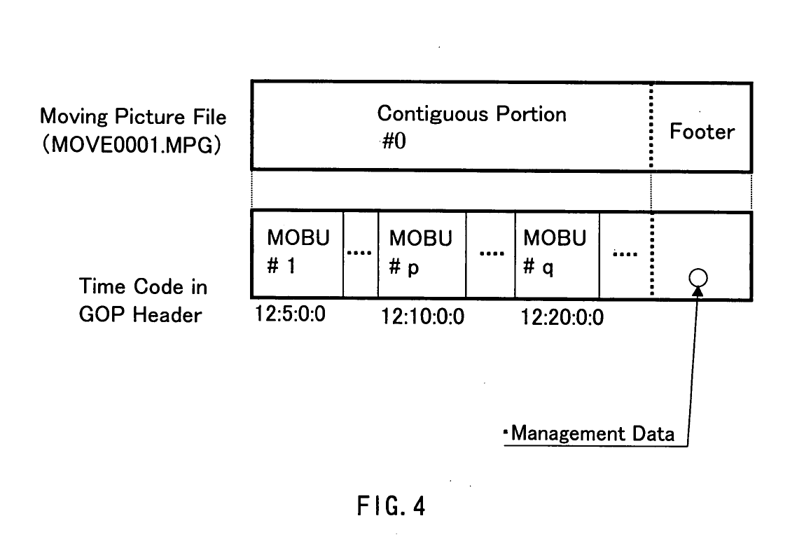

FIG. 4 is a schematic diagram showing the configuration of a moving picture file when an another user recorded the same broadcast program as the first program of FIG. 3. FIG. 4 shows that the another user started to record the contiguous portion #0 after a five-minute delay. That is, “12:5:0:0” is set in MOBU #1, “12:10:0:0” is set in MOBU #p and “12:20:0:0” is set in MOBU #q.

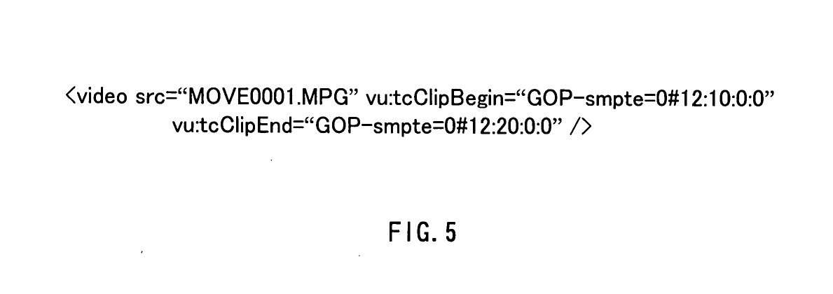

FIG. 5 is a diagram showing the contents of a play list file in the first embodiment. In FIG. 5, the play list file is described by using SMIL language for reproducing, as the reproduction period, from MOBU #m (time code value in the GOP header is “12:10:0:0”) to MOBU #n (time code value in the GOP header is “12:20:0:0”) in the contiguous portion #0 shown in FIG. 3. It should be noted that the description “vu:” in FIG. 5 is in compliance with the SMIL 2.0 standard for representing to be unique to the vender. However, any letters can be used for “vu” itself.

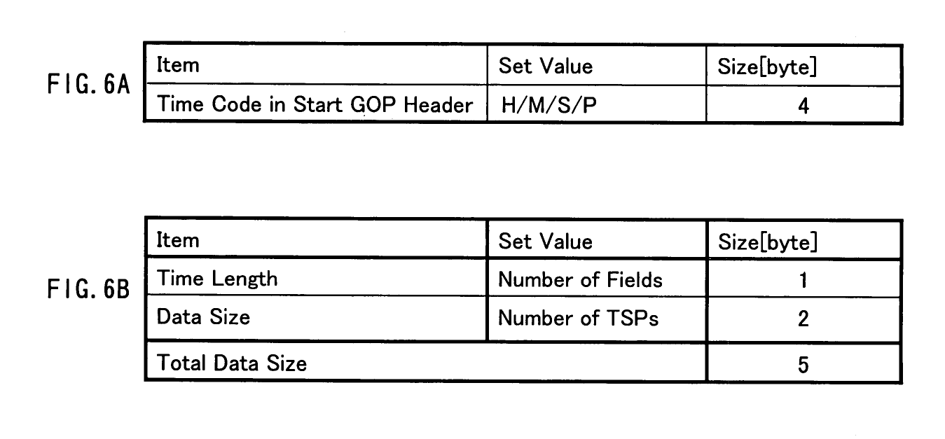

FIGS. 6A and 6B are diagrams showing the contents of the management data held in the footer of each moving picture file in this embodiment. FIG. 6A is a diagram showing the contents of the management data of each contiguous data portion. As shown in FIG. 6A, as the management data of each contiguous data portion, the time code in the start GOP header in the start MOBU is held in the form of hours (H)/minutes (M)/seconds (S)/number of pictures (P). FIG. 6B is a diagram showing the contents of the management data of each MOBU. As shown in FIG. 6B, as the management data of each MOBU, the number of video fields contained in a single MOBU is held in the form of a time length and the data size of a single MOBU is held in the form of the number of transport packets (TSPs).

The following describes the reproducing operation with a play list in the audio/video data recording/reproducing apparatus 2 of this embodiment configured as described above.

When the reproducing control section 162 performs reproduction by referring to a play list, the reproducing control section 162 first analyzes the play list shown in FIG. 5 and extracts the portion “vu:tcClipBegin=“GOP-smpte=0#12:10:0;0”” stating the reproduction start point and the portion “vu:tcClipEnd=“GOP-smpte=0#12:20:0:0:0”” stating the reproduction end point. Then, it refers to the management data in the footer, and identifies the data position in the moving picture file corresponding to “tcClipBegin”. That is, it identifies the data position of the MOBU corresponding to “12:10:0:0” by extracting the time code (12:0:0:0) in the start GOP header of the contiguous portion #0 from the management data and further extracting the time length (number of fields) and the data size of each MOBU. Likewise, it identifies the data position of the MOBU corresponding to “12:20:0:0” of “tcClipEnd”. Thus, the reproducing control section 162 reproduces the period from the reproduction start point to the reproduction end point, whose data positions have been identified.

In the above-described manner, it is possible to specify the reproduction period of a moving picture file with a play list by using the time at which video was generated.

Even when an another user recorded a moving picture file as shown in FIG. 4, whose start is 5 minutes shorter after that shown in FIG. 3, the same play list of FIG. 5 may be used for reproducing the same place. The reason is that the reproduction start point specified with the play list can be identified since “12:5:0:0”, which is the time code of the start GOP header, is recorded as the management data of each contiguous data portion in the footer of the moving picture file of FIG. 4.

Even when any period other than the reproduction period specified with the play list of FIG. 5 (e.g., the period from 12:1:0:0 to 12:2:0:0) among the data in the moving picture file shown in FIG. 3 is deleted and the deletion process is reflected to the management data, it is not necessary to change the play list of FIG. 5 from its state before the deletion.

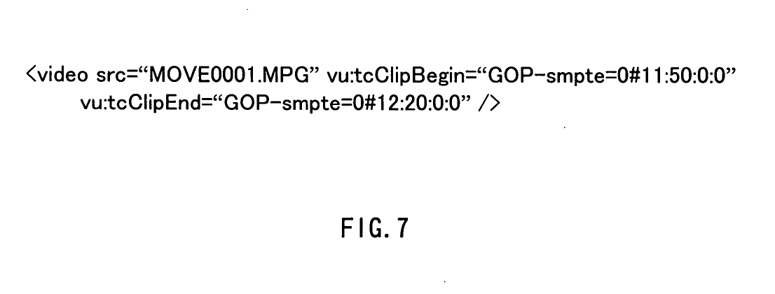

Here, when the reproduction start point is specified as “0#11:50:0:0” as in the case of the play list shown in FIG. 7, a period not included in the contiguous data portion #0 of the moving picture file of the FIG. 3 is specified, so that the period from “11:50:0:0” to “12:0:0:0”, which is the period that is not included, is ignored and reproduction is started immediately from the start of the file whose time code is “12:0:0:0”. This enables an appropriate reproducing control with a single play list, for example, even for a moving picture file in which the time code of the start of the file is “12:15:0:0”.

However, this operation is different from the operation specified by SMIL 2.0. The reason is that, according to the specifications in SMIL 2.0, when a portion not included in the moving picture file is specified, the entire description in FIG. 7 is ignored, or a blue back screen is displayed for the excessively specified time, for the time corresponding to the excess period. Therefore, the above-described process is executed only when “vu:tcClipBegin” or “vu:tcClipEnd” is described.

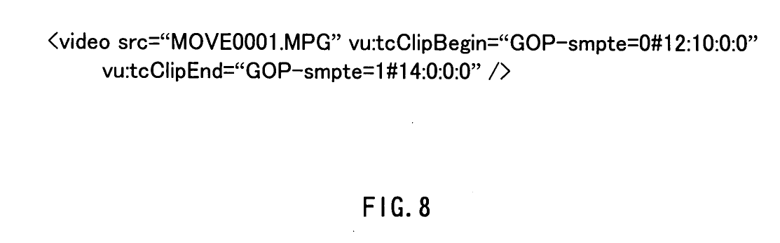

When the recording end point is specified as “1#14:0:0:0” as in the case of the play list shown in FIG. 8, the data position corresponding to “14:0:0:0” in the contiguous data portion #1 in the moving picture file of FIG. 3 is identified.

Although the recording time was recorded in a time code field in a GOP header in this embodiment, it may be recorded in user data between a sequence header and a GOP header.

Although a broadcast program was recorded in this embodiment, camera signals connected to the audio/video data recording/reproducing apparatus may be recorded.

Although in this embodiment, the broadcast program and the play list arrive at the audio/video data recording/reproducing apparatus 2 via separate transmission paths (e.g., the former by a broadcast wave and the latter by downloading from the Internet 4 or by production through the operations by a user) and are recorded, both of the files may arrive at the audio/video data recording/reproducing apparatus 2 via the same path (e.g., the Internet or a broadcast wave).

Although a time code field in a GOP header was used in the first embodiment, the same value may correspond to the value of a PTS (presentation time stamp).

### Second Embodiment

As a second embodiment of the present invention, the reproduction of moving pictures with a play list is described in the case of recording the moving pictures by capturing with a video camera serving as the audio/video data recording/reproducing apparatus 2. The second embodiment and the first embodiment are different with regard to the description contents of the play list and the management data in the footer in the moving picture file.

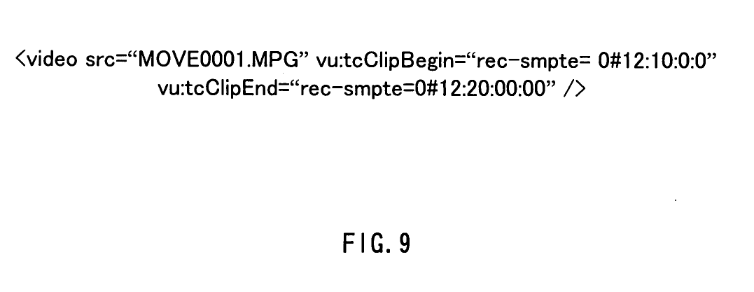

FIG. 9 is a diagram showing the contents of the play list file in the second embodiment of the present invention. In FIG. 9, the play list file specifies, as the reproduction period, a period from the point at which the recording time in the contiguous portion #0 corresponds to “12:10:0:0” to the point at which the recording time in the contiguous portion #1 corresponds to “12:20:0:0”. The play list of this embodiment is different from the play list of the first embodiment (FIG. 5) in that “rec-smpte=” is used in FIG. 9 to specify the reproduction start point and the reproduction end point, whereas “GOP-smpte=” is used in FIG. 5. Here, the recording time is a recording time at which the audio/video data recording/reproducing apparatus 2 records moving pictures.

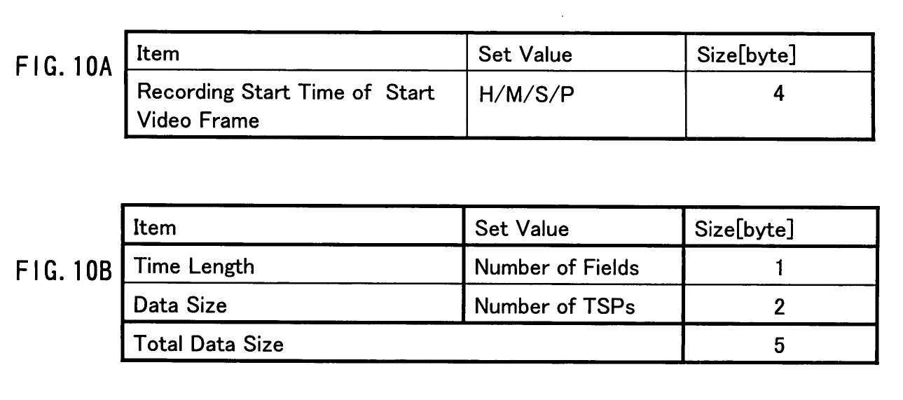

FIGS. 10A and 10B are diagrams showing the contents of the management data held in the footer of each moving picture file in this embodiment. FIG. 10A is a diagram showing the contents of the management data of each contiguous data portion. As shown in FIG. 10A, as the management data of each contiguous data portion, the recording start time of the start video frame in the start MOBU is recorded in the form of hours (H)/minutes (M)/seconds (S)/number of pictures. FIG. 10B is a diagram showing the contents of the management data of each MOBU. As shown in FIG. 10B, as the management data of each MOBU, the number of video fields contained in a single MOBU is held in the form of a time length, and the data size of a single MOBU is held in the form of the number of transport packets (TSPs).

The following describes the reproducing operation with a play list in the audio/video data recording/reproducing apparatus 2 of this embodiment configured as described above.

When the reproducing control section 162 performs reproduction while referring to a play list, the reproducing control section 162 first analyzes the play list of FIG. 10 and extracts the portion “vu:tcClipBegin=“rec-smpte=0#12:10:0;0”” stating the reproduction start point and the portion “vu:tcClipEnd=“rec-smpte=0#12:20:0:0”” stating the reproduction end point. Then, it refers to the management data in the footer, and identifies the data position in the moving picture file corresponding to “tcClipBegin”. That is, it identifies the data position of the MOBU corresponding to “12:10:0:0” by extracting the capturing start time (12:0:0:0) of the start of the video of the contiguous portion #0 from the management data and further extracting the time length (number of fields) and the data size of each MOBU. Likewise, it identifies the data position of the MOBU corresponding to “12:20:0:0” of “tcClipEnd”. Thus, the reproducing control section 162 reproduces the period from the reproduction start point to the reproduction end point, whose data positions have been identified.

In the above-described manner, it is possible to specify the reproduction period of a moving picture file with a play list by using the time at which the recording of video was started.

Even when a period other than the reproduction period specified with the play list of FIG. 9 among the data in the moving picture file shown in FIG. 3 is deleted and the deletion process is reflected to the management data, it is not necessary to change the play list of FIG. 9 from its state before the deletion.

### Third Embodiment

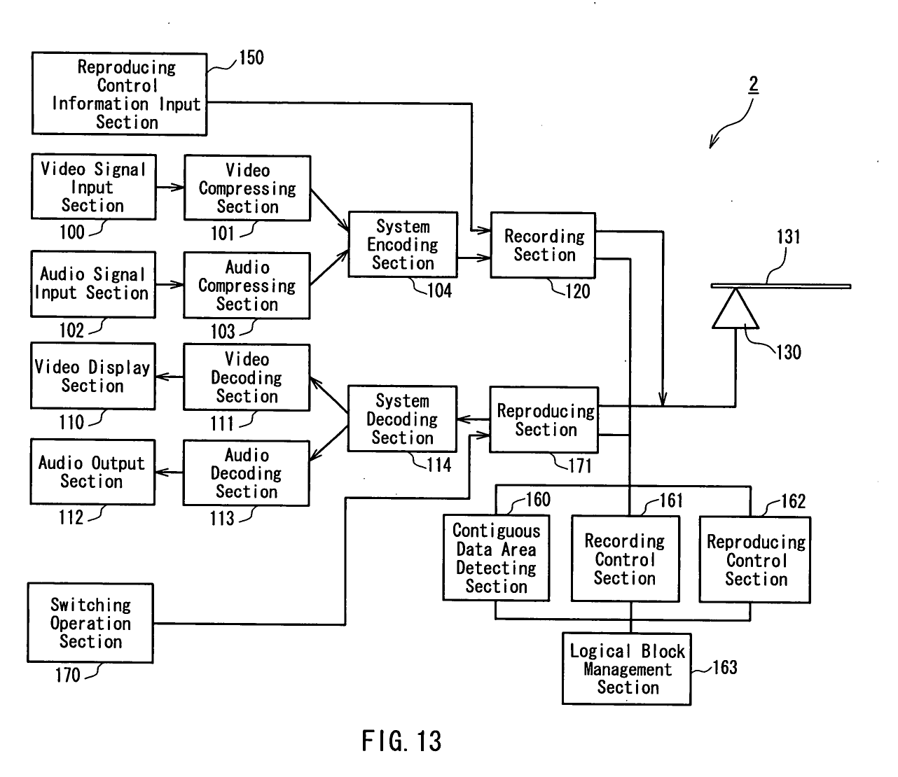

FIG. 13 shows the configuration of an audio/video data recording/reproducing apparatus 20 according to a third embodiment of the present invention. This embodiment is different from the first embodiment only in that a switching operation section 170 has been added and an additional content of a reproduction process of receiving an operation from the switching operation section has been added to the reproducing section 171. A user can send a switching request for the reproduction angle via the switching operation section at the time of reproduction.

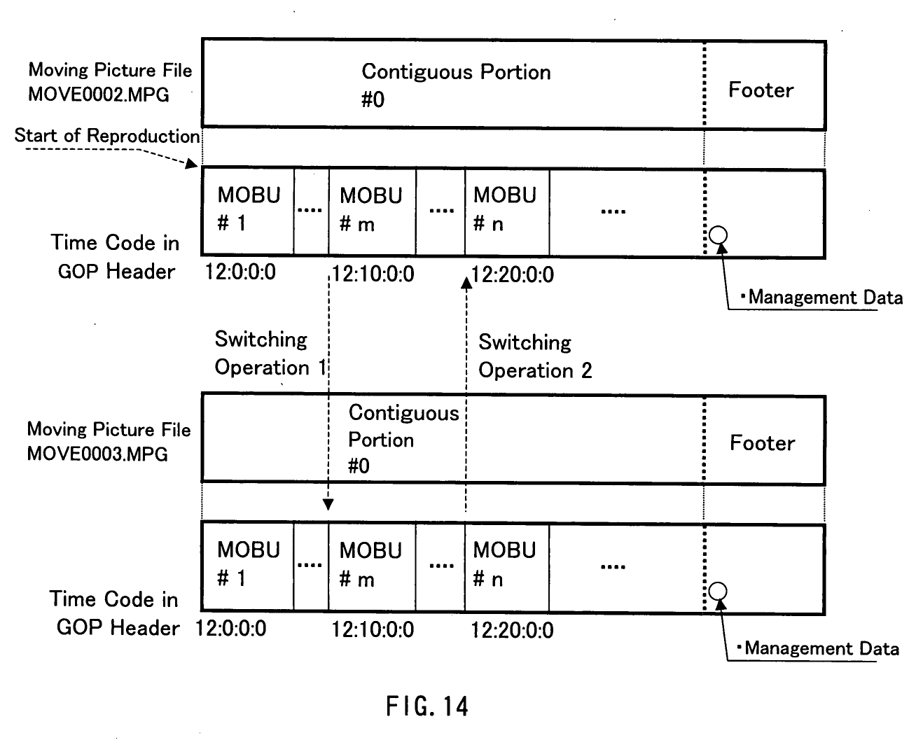

FIG. 14 is a diagram showing the data structure of the recorded contents on a DVD-RAM in the third embodiment. On an optical disk, two moving picture files, namely, MOVE0002.MPG and MOVE0003.MPG, are recorded. Here, MOVE0002.MPG and MOVE0003.MPG are moving picture files in which the same sports event was captured from different angles, and the moving picture files were recorded by separate recording/reproducing apparatuses at the time of capturing and copied on the DVD-RAM of a single recording/reproducing apparatus 20. Additionally, the moving picture files have the management data shown in FIG. 6 or FIG. 10.

When the reproducing section 171 receives a switching signal from the switching operation section 170 after starting the reproduction of the moving picture file MOVE0002.MPG, it searches the management data on the DVD-RAM to check if there are any moving picture files having the same capturing time. At this time, if there are moving picture data having the same capturing time, it switches to the reproduction process of the portion corresponding to the moving picture file MOVE0003.MPG, as shown in a switching operation 1 of FIG. 14. As a result, the moving picture data captured from a different angle are reproduced. Then, when the reproducing section receives a switching signal from the switching operation section again, it searches the management data on the DVD-RAM to check if there are any moving picture files having the same capturing time. At this time, if there are other moving picture data having the same capturing time, it switches to the reproduction of the portion corresponding to MOVE0002.MPG, as shown in a switching operation 2 of FIG. 14.

With the above-described reproduction process, it becomes possible to realize multi-angle reproduction with ease.

Although there are two moving picture files corresponding to the same capturing time in this embodiment, there may be three or more of such files. In this case, one of the three files is selectively displayed every time a switching operation is performed.

Although the recording medium is an optical disk in the above-described embodiments, it may be any disk-shaped recording medium such as, for example, an optical disk like DVD-RAM, MO, DVD-R, DVD-RW, DVD+RW, CD-R or CD-RW and a hard disk, or a flash memory.

Similarly, although the reading/writing head is a pick-up in the embodiments, it will be a pick-up and a magnetic head in the case of MO, and a magnetic head in the case of a hard disk.

Although the moving picture streams and the play list arrive via separate paths in FIG. 1, they may follow the same path.

When the reproduction start time or the reproduction end time specified with the play list does not coincide exactly with the start position of a MOBU in the above-described embodiments, it may be adjusted to be shorter than the specified period, or may be adjusted to be longer than the specified period. In this manner, it may be varied from the specified time in a maximum MOBU unit. More preferably, the reproduction start point and the reproduction end point can be controlled in a unit of a frame or field.

Although a transport stream under the MPEG2 standard is recorded in the above-described embodiments, it may be a program stream or PES stream. Alternatively, it may be a stream in which packets of a total of 192 bytes are made contiguous by producing an arrival timestamp for each transport packet at a clock of 27 MHz and adding it before or after the transport packet. The system stream may be a system stream (including a MP4 file) in compliance with the MPEG1 standard Part 1 (system) or the MPEG4 standard Part 1 (system). It may be a stream in which the video stream contained in the system stream is in compliance with the MPEG4 standard Part 2 (Visual) or Part 10 (AVC) under discussion. Alternatively, it may be a system stream and a video elementary stream that are in compliance with the Motion JPEG 2000 standard.

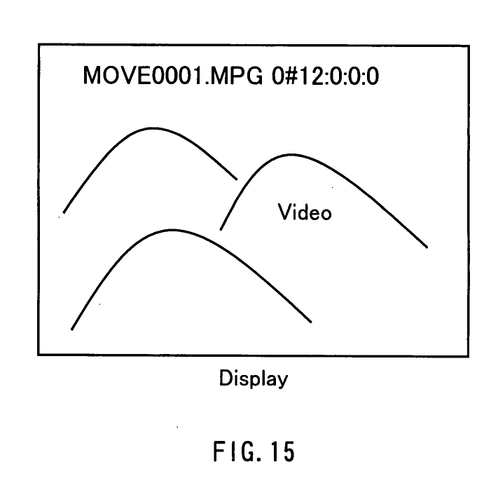

In addition, as a method for identifying video frame units at the time of reproduction, a file name, a number identifying a contiguous portion (identification number #0 or #1 of the contiguous portion #0 or the contiguous portion #1 in the first embodiment), and a time code (hours, minutes, seconds and frame number) representing the recording time may be displayed on a display in the above-described embodiments. This allows also a user to identify uniquely any displayed video frame on a DVD-RAM. FIG. 15 shows an example of the display for identifying a video frame, taking the start frame of the moving picture file MOVE0001.MPG shown in FIG. 3 as an example.

Although a period in which video is contiguous is identified by a single identification number, it may be divided by plural identification numbers.

As described above, according to the present invention, it is possible to specify a period to be reproduced by describing a capturing time or a recording time directly in a play list, so that a specification that is intuitive and easy, unlike in the prior art, becomes possible.

Additionally, it is not necessary to make any change to a play list at all when unnecessary scenes are deleted from a recorded moving picture file after producing the play list.

Furthermore, it becomes possible to specify the reproduction period with a single play list, even when the recording start time of a moving picture file in which a broadcast program is recorded differs from one user to another.

1. An audio/video data recording/reproducing apparatus comprising:
audio/video data generating means that generate audio/video data from an audio signal and/or video signal;
audio/video data recording means that record, as a file, audio/video data generated by the audio/video data generating means; and
reproducing means that reproduce a specified time period of audio and/or video data recorded by the audio/video data recording means,
wherein the audio/video data recording means further record identification information for identifying a time-wise contiguous recording period and further record a recording start time in a unit of the identification information, and
the reproducing means identify the specified time period based on a name of the file, the identification information and position information taking the recording start time as a starting point.

2. The audio/video data recording/reproducing apparatus according to claim 1,
wherein, when it is determined, by referring to the recording start time, that the audio and/or video data corresponding to the specified time period contain an unrecorded portion, the reproducing means immediately reproduce only a recorded portion.

3. A recording medium recorded by the audio/video data recording/reproducing apparatus according to claim 1.

4. An audio/video data recording/reproducing apparatus comprising:
audio/video data recording means that record, as a file, audio/video data in which time information is inserted for every predetermined signal unit; and
reproducing means that reproduce a specified time period of audio and/or video data recorded by the audio/video data recording means,
wherein the audio/video data recording means further record identification information for identifying a time-wise contiguous recording period and further record the time information of a start in a single contiguous recording period in a unit of the identification information, and
the reproducing means identify the specified time period based on a name of the file, the identification information and position information taking the time information as a starting point.

5. The audio/video data recording/reproducing apparatus according to claim 4,
wherein the time information is information including a time at which an audio signal and/or video signal is generated before being converted into the audio and/or video data.

6. The audio/video data recording/reproducing apparatus according to claim 4,
wherein the audio/video data are MPEG data, and the audio/video data recording means record the time information in a time code field in a GOP header.

7. The audio/video data recording/reproducing apparatus according to claim 4,
wherein, when it is determined, by referring to the time information, that the audio and/or video data corresponding to the specified time period contain an unrecorded portion, the reproducing means immediately reproduce only a recorded portion.

8. A recording medium recorded by the audio/video data recording/reproducing apparatus according to claim 4.

9. An audio/video data recording/reproducing method comprising the steps of:
generating audio/video data from an audio signal and/or video signal;
recording the generated audio/video data as a file; and
reproducing a specified time period of the recorded audio and/or video data,
wherein the recording step comprises a step of further recording identification information for identifying a time-wise contiguous recording period and further recording a recording start time in a unit of the identification information, and
the reproducing step comprises a step of identifying the specified time period based on a name of the file, the identification information and position information taking the recording start time as a starting point.

10. The audio/video data recording/reproducing method according to claim 9,
wherein, when it is determined, by referring to the recording start time, that the audio and/or video data corresponding to the specified time period contain an unrecorded portion, the reproducing step comprises a step of immediately reproducing only a recorded portion.

11. A recording medium recorded by the audio/video data recording/reproducing method according to claim 9.

12. An audio/video data recording/reproducing method comprising the steps of:
recording, as a file, audio/video data in which time information is inserted for every predetermined signal unit; and
reproducing a specified time period of the recorded audio and/or video data,
wherein the recording step comprises a step of further recording identification information for identifying a time-wise contiguous recording period and further recording the time information of a start in a single contiguous recording period in a unit of the identification information, and
the reproducing step comprises a step of identifying the specified time period based on a name of the file, the identification information and position information taking the time information as a starting point.

13. The audio/video data recording/reproducing method according to claim 12,
wherein the time information is information including a time at which an audio signal and/or video signal is generated before being converted into the audio and/or video data.

14. The audio/video data recording/reproducing method according to claim 12,
wherein the audio/video data are MPEG data, and the time information is recorded in a time code field in a GOP header.

15. The audio/video data recording/reproducing method according to claim 12,
wherein, when it is determined, by referring to the time information, that the audio and/or video data corresponding to the specified time period contain an unrecorded portion, the reproducing step comprises a step of immediately reproducing only a recorded portion.

16. A recording medium recorded by the audio/video data recording/reproducing method according to claim 12.

17. An audio/video data reproducing apparatus comprising
reproducing means that reproduce a specified time period of audio and/or video data recorded as a file,
wherein the reproducing means identify the specified time period based on a name of the file, identification information recorded for identifying a time-wise contiguous recording period and position information taking, as a starting point, a recording start time recorded in a unit of the identification information.

18. The audio/video data reproducing apparatus according to claim 17,
wherein, when it is determined, by referring to the recording start time, that the audio and/or video data corresponding to the specified time period contain an unrecorded portion, the reproducing means immediately reproduce only a recorded portion.

19. An audio/video data reproducing apparatus comprising
reproducing means that reproduce a specified time period of audio and/or video data recorded as a file in which time information is inserted for every predetermined signal unit,
wherein the reproducing means identify the specified time period based on a name of the file, identification information recorded for identifying a time-wise contiguous recording period and position information taking, as a starting point, the time information of a start in a single contiguous recording period recorded in a unit of the identification information.

20. The audio/video data reproducing apparatus according to claim 19,
wherein the time information is information including a time at which an audio signal and/or video signal is generated before being converted into the audio and/or video data.

21. The audio/video data reproducing apparatus according to claim 19,
wherein the audio/video data are MPEG data, and the reproducing means reproduce the time information recorded in a time code field in a GOP header.

22. The audio/video data reproducing apparatus according to claim 19,
wherein, when it is determined, by referring to the time information, that the audio and/or video data corresponding to the specified time period contain an unrecorded portion, the reproducing means immediately reproduce only a recorded portion.

23. An audio/video data recording/reproducing system comprising:
audio/video data generating means that convert an audio signal and/or video signal into audio/video data and insert time information in the audio/video data for every predetermined signal unit;
transmission means that transmit audio/video data generated by the audio/video data generating means;
audio/video data recording means that record, as a file, audio/video data transmitted by the transmission means; and
reproducing means that reproduce a specified time period of audio and/or video data recorded by the audio/video data recording means,
wherein the audio/video data recording means further record identification information for identifying a time-wise contiguous recording period and further record the time information of a start in a single contiguous recording period in a unit of the identification information, and
the reproducing means identify the specified time period based on a name of the file, the identification information and position information taking the time information as a starting point.

24. The audio/video data recording/reproducing system according to claim 23,
wherein the time information is information including a time at which an audio signal and/or video signal is generated before being converted into the audio/video data.

25. The audio/video data recording/reproducing system according to claim 23,
wherein the audio/video data generating means generate MPEG data, and the audio/video data recording means record the time information in a time code field in a GOP header.

26. The audio/video data recording/reproducing system according to claim 23,
wherein, when it is determined, by referring to the time information, that the audio and/or video data corresponding to the specified time period contain an unrecorded portion, the reproducing means immediately reproduce only a recorded portion.

27. A recording medium recorded by the audio/video data recording/reproducing system according to claim 23.

28. An audio/video data recording/reproducing system comprising:
audio/video data sending means that send audio and/or video data in which time information is inserted at a predetermined interval;
first transmission means that transmit the audio/video data;
reproducing control information sending means that send reproducing control information regarding the audio and/or video data;
second transmission means that transmit the reproducing control information;
recording means that record the audio data and/or video data transmitted by the first transmission means and the reproducing control information transmitted by the second transmission means; and
reproducing means that reproduce the audio and/or video data for a selected reproduction period in accordance with the reproducing control information.

29. The audio/video data recording/reproducing system according to claim 28,
wherein, when it is determined, by referring to the time information, that the audio and/or video data corresponding to a reproduction period specified in the reproducing control information contain an unrecorded portion, the reproducing means immediately reproduce only a recorded portion.

30. A recording medium recorded by the audio/video data recording/reproducing system according to claim 28.

31. An audio/video data recording/reproducing method comprising the steps of:
converting an audio signal and/or video signal into audio/video data and inserting time information in the audio/video data for every predetermined signal unit;
transmitting the audio/video data;
recording transmitted audio/video data as a file; and
reproducing a specified time period of recorded audio and/or video data,
wherein the recording step comprises a step of further recording identification information for identifying a time-wise contiguous recording period and further recording the time of information of a start in a single contiguous recording period in a unit of the identification information, and
the reproducing step comprises a step of identifying the specified time period based on a name of the file, the identification information and position information taking the time information as a starting point.

32. The audio/video data recording/reproducing method according to claim 31,
wherein the time information is information including a time at which an audio signal and/or video signal is generated before being converted into the audio/video data.

33. The audio/video data recording/reproducing method according to claim 31,
wherein the audio/video data are MPEG data, and the time information is recorded in a time code field in a GOP header.

34. The audio/video data recording/reproducing method according to claim 31,
wherein, when it is determined, by referring to the time information, that the audio and/or video data corresponding to the specified time period contain an unrecorded portion, the reproducing step comprises a step of immediately reproducing only a recorded portion.

35. A recording medium recorded by the audio/video data recording/reproducing method according to claim 31.

36. An audio/video data recording/reproducing method comprising:
a step of sending audio and/or video data in which time information is inserted at a predetermined interval;
a first transmission step of transmitting the audio/video data;
a step of sending reproducing control information regarding the audio data and/or video data;
a second transmission step of transmitting the reproducing control information;
a step of recording the audio data and/or video data transmitted in the first transmission step and the reproducing control information transmitted in the second transmission step; and
a step of reproducing the audio data and/or video data for a selected reproduction period in accordance with the reproducing control information.

37. The audio/video data recording/reproducing method according to claim 36,
wherein, when it is determined, by referring to the time information, that the audio and/or video data corresponding to a reproduction period specified in the reproducing control information contain an unrecorded portion, the reproducing step comprises a step of immediately reproducing only a recorded portion.

38. A recording medium recorded by the audio/video data recording/reproducing method according to claim 36.

39. A data structure that specifies a time period for reproducing audio and/or video data recorded as a file, the data structure having a format including at least a name of the file, information relating to a generation of an audio signal and/or video signal before being converted into the audio data and/or video data, identification information for identifying a time-wise contiguous recording period, a reproduction start time and a reproduction end time.

40. An audio/video data recording/reproducing apparatus comprising:
audio/video data generating means that generate audio/video data from an audio signal and/or video signal;
audio/video data recording means that record audio/video data generated by the audio/video data generating means;
reproducing means that reproduce audio and/or video data recorded by the audio/video data recording means; and
switching means that send to the reproducing means a switching instruction to switch audio and/or video data to be reproduced to different audio and/or video data,
wherein the audio/video data recording means further record a recording start time, and
the reproducing means, when receiving the switching instruction, detect audio/video data captured at the same recording time as the recording time of audio/video data that are reproduced immediately before and reproduce the detected data after switching to the detected data.

41. An audio/video data reproducing apparatus comprising:
reproducing means that reproduce audio/video data containing recording start time information; and
switching means that send to the reproducing means, a switching instruction to switch audio and/or video data to be reproduced to different audio and/or video data,
wherein the reproducing means, when receiving the switching instruction, detect audio/video data captured at the same recording time as the recording time of audio/video data that are reproduced immediately before and reproduce the detected data after switching to the detected data.

42. An audio/video data reproducing method comprising:
a reproducing step of reproducing audio/video data containing recording start time information; and
a switching step of sending to reproducing means, a switching instruction to switch audio and/or video data to be reproduced to different audio and/or video data,
wherein the reproducing step, when the switching instruction is received, comprises a step of detecting audio/video data captured at the same recording time as the recording time of audio/video data that are reproduced immediately before and reproducing the detected data after switching to the detected data.

43. An audio/video data recording/reproducing apparatus comprising:
audio/video data recording means that record audio/video data; and
reproducing means that reproduce audio and/or video data recorded by the audio/video data recording means,
wherein the audio/video data recording means further record identification information for identifying a time-wise contiguous recording period and further record a recording start time in a unit of the identification information, and
the reproducing means display a name of the file, the identification information, hours, minutes and seconds based on the recording start time, and a frame number based on the recording start time.
